(19) United States
(12) Patent Application Publication
(10) Pub. No.: US 2025/0121757 A1
(43) Pub. Date: Apr. 17, 2025

(54) HEADREST

(71) Applicant: TS TECH CO., LTD., Asaka-shi, Saitama (JP)

(72) Inventors: Nobuyuki TEZUKA, Tochigi (JP); Naoya MATSUMOTO, Tochigi (JP)

(21) Appl. No.: 18/685,299

(22) PCT Filed: Sep. 26, 2022
(86) PCT No.: PCT/JP2022/035665

§ 371 Date: Feb. 21, 2024

Related U.S. Application Data
(60) Provisional application No. 63/261,755, filed on Sep. 28, 2021.

(51) Int. Cl. B60N 2/879; B60N 2/818

(52) U.S. Cl. CPC B60N 2/879; B60N 2/818

(57) ABSTRACT

A headrest of a vehicle seat includes a headrest pillar supported by a seat back; a headrest body coupled to the headrest pillar; at least one speaker supported by the headrest body; a pad for covering the headrest body, the pad having at least one pad opening which faces the at least one speaker; a mesh-shaped shape retainer provided on the outer surface of the pad so as to cover the at least one pad opening, edges of the shape retainer being coupled to the outer surface of the pad; and a skin cover for covering the pad and the shape retainer.

### TECHNICAL FIELD

The present invention relates to a headrest for a vehicle seat.

### BACKGROUND ART

Patent Document 1 discloses a headrest having an internal speaker. The headrest comprises a frame defining an internal space, a pad provided on the outer surface of the frame, and a skin cover for covering the pad. A speaker is provided toward the internal space, and the frame also defines through-holes. The pad and skin cover have ventilation holes communicatively connected to the through-holes. Sound produced by the speaker is transmitted to the outside of the headrest through the internal space, the through-holes and the ventilation holes.

### PRIOR ART DOCUMENT(S)

### Patent Document(s)

Patent Document 1: JPH06-52615U

### SUMMARY OF THE INVENTION

### Task to be Accomplished by the Invention

A headrest as one disclosed in Patent Document 1 has a problem that the ventilation holes formed in the pad and skin cover cause partial reduction in the stiffness of the pad and skin cover, resulting in the headrest having different softness at portions where the ventilation holes are formed, which can cause discomfort to a user's head.

The present invention has been made in view of the problem of the prior art, and a primary object of the present invention is to provide a headrest having a pad and speakers therein and configured to reduce partial deformation of the pad.

### Means to Accomplish the Task

In order to accomplish the above-described task, an aspect of the present invention provides a headrest (4) for a vehicle seat (1), the headrest comprising: a headrest pillar (11) supported by a seat back (3); a headrest body (12) coupled to the headrest pillar (11); at least one speaker (13) supported by the headrest body; a pad (14) for covering the headrest body, the pad having at least one pad opening (121) which faces the at least one speaker; a shape retainer (15) which is mesh-shaped, and provided on the outer surface of the pad so as to cover the at least one pad opening, edges of the shape retainer being coupled to the outer surface of the pad; and a skin cover (16) for covering the pad and the shape retainer.

According to this configuration, the headrest having a pad and speakers is configured to reduce partial deformation of the pad. The shape retainer adds stiffness to the pad, which prevents deformation of pad opening parts, i.e., parts of the surface of the pad where pad openings open.

The above headrest may be further configured such that a frame (125) is provided at an edge of the shape retainer, the frame being stiffer than the shape retainer, and wherein the frame is coupled to the pad.

In this configuration, the shape retainer and the frame further prevent deformation of the pad opening parts.

The above headrest may be further configured such that the at least one pad opening opens on the front surface of the pad, and wherein the shape retainer extends vertically across the front surface of the pad, and is coupled to the top and bottom edges of the pad.

In this configuration, the shape retainer extends over a relatively wide area of the surface, thereby enabling distribution of the load applied to the pad, which further prevents partial deformation of the pad.

The above headrest may be further configured such that the headrest body comprises: a support plate (35) which is coupled to the headrest pillar and faces frontward and backward; and a front core (37) which is provided on the front side of the support plate such that an internal space (36) is formed between the front core and the support plate; and a rear core (38) which is provided on the rear side of the support plate, wherein the at least one speaker is supported by the front surface of the support plate and is provided in the internal space, wherein the front core has at least one core opening (66) which extends therethrough in a front-to-rear direction and faces the at least one speaker, and wherein the at least one speaker is surrounded by a first sound absorber (117).

In this configuration, the first sound absorber reduces vibrations transmitted from the speakers to the support plate, front core, and rear core.

The above headrest may be further configured such that the at least one speaker comprises a left speaker and a right speaker which are provided at left and right parts of the front surface of the support plate, respectively, and wherein the headrest further comprises a partition wall (69) which is provided at a center part of the internal space along a left-to-right direction so as to divide the internal space into left and right subspaces.

This configuration reduces interference between sound outputs from the left and right speakers.

The above headrest may be further configured such that the at least one core opening comprises left and right core openings, and wherein the headrest further comprises funnels (81) which are provided at the edges of the left and right core openings and extend toward the left and right speakers, respectively.

In this configuration, the funnels regulate the respective directions of sound outputs from the speakers, which reduces interference between sound outputs from the left and right speakers.

The above headrest may be further configured such that the headrest further comprises second sound absorbers (118) provided between the partition wall and the left speaker and between the partition wall and the right speakers, respectively.

This configuration reduces interference between sound outputs from the left and right speakers.

The above headrest may be further configured such that the partition wall is formed of a flexible sound absorber.

This configuration reduces interference between sound outputs from the left and right speakers.

The above headrest may be further configured such that the front core and the rear core are coupled to each other such that the support plate is interposed between the front core and the rear core, and wherein the support plate is in secure contact with the front core and the rear core, with respective cushioning parts (111 to 114) provided therebetween.

This configuration reduces vibrations transmitted from the support plate to the front core and rear core.

The above headrest may be further configured such that the headrest further comprises a rear cover (130) coupled to the rear surface of the rear core, and a vibration damper (138) provided on the front surface of the rear cover.

This configuration prevents rearward transmission of sound from the headrest.

### Effect of the Invention

In order to accomplish the above-described task, an aspect of the present invention provides a headrest (4) for a vehicle seat (1), the headrest comprising: a headrest pillar (11) supported by a seat back (3); a headrest body (12) coupled to the headrest pillar (11); at least one speaker (13) supported by the headrest body; a pad (14) for covering the headrest body, the pad having at least one pad opening (121) which faces the at least one speaker; a shape retainer (15) which is mesh-shaped, and provided on the outer surface of the pad so as to cover the at least one pad opening, edges of the shape retainer being coupled to the outer surface of the pad; and a skin cover (16) for covering the pad and the shape retainer.

According to this configuration, the headrest having a pad and speakers is configured to reduce partial deformation of the pad. The shape retainer adds stiffness to the pad, which prevents deformation of pad opening parts, i.e., parts of the surface of the pad where pad openings open.

The above headrest may be further configured such that a frame (125) is provided at an edge of the shape retainer, the frame being stiffer than the shape retainer, and wherein the frame is coupled to the pad.

In this configuration, the shape retainer and the frame further prevent deformation of the pad opening parts.

The above headrest may be further configured such that the at least one pad opening opens on the front surface of the pad, and wherein the shape retainer extends vertically across the front surface of the pad, and is coupled to the top and bottom edges of the pad.

In this configuration, the shape retainer extends over a relatively wide area of the surface, thereby enabling distribution of the load applied to the pad, which further prevents partial deformation of the pad.

The above headrest may be further configured such that the headrest body comprises: a support plate (35) which is coupled to the headrest pillar and faces frontward and backward; and a front core (37) which is provided on the front side of the support plate such that an internal space (36) is formed between the front core and the support plate; and a rear core (38) which is provided on the rear side of the support plate, wherein the at least one speaker is supported by the front surface of the support plate and is provided in the internal space, wherein the front core has at least one core opening (66) which extends therethrough in a front-to-rear direction and faces the at least one speaker, and wherein the at least one speaker is surrounded by a first sound absorber (117).

In this configuration, the first sound absorber reduces vibrations transmitted from the speakers to the support plate, front core, and rear core.

The above headrest may be further configured such that the at least one speaker comprises a left speaker and a right speaker which are provided at left and right parts of the front surface of the support plate, respectively, and wherein the headrest further comprises a partition wall (69) which is provided at a center part of the internal space along a left-to-right direction so as to divide the internal space into left and right subspaces.

This configuration reduces interference between sound outputs from the left and right speakers.

The above headrest may be further configured such that the at least one core opening comprises left and right core openings, and wherein the headrest further comprises funnels (81) which are provided at the edges of the left and right core openings and extend toward the left and right speakers, respectively.

In this configuration, the funnels regulate the respective directions of sound outputs from the speakers, which reduces interference between sound outputs from the left and right speakers.

The above headrest may be further configured such that the headrest further comprises second sound absorbers (118) provided between the partition wall and the left speaker and between the partition wall and the right speakers, respectively.

This configuration reduces interference between sound outputs from the left and right speakers.

The above headrest may be further configured such that the partition wall is formed of a flexible sound absorber.

This configuration reduces interference between sound outputs from the left and right speakers.

The above headrest may be further configured such that the front core and the rear core are coupled to each other such that the support plate is interposed between the front core and the rear core, and wherein the support plate is in secure contact with the front core and the rear core, with respective cushioning parts (111 to 114) provided therebetween.

This configuration reduces vibrations transmitted from the support plate to the front core and rear core.

The above headrest may be further configured such that the headrest further comprises a rear cover (130) coupled to the rear surface of the rear core, and a vibration damper (138) provided on the front surface of the rear cover.

This configuration prevents rearward transmission of sound from the headrest.

### BRIEF DESCRIPTION OF THE DRAWINGS

FIG. 1 is a perspective view of a seat provided with a headrest according to one embodiment of the present invention;

FIG. 2 is a perspective view of the headrest of the embodiment of FIG. 1;

FIG. 3 is an exploded perspective view of the headrest of the embodiment of FIG. 1;

FIG. 4 is a perspective view showing a headrest body and a headrest pillar;

FIG. 5 is a perspective view showing a support plate viewed from the rear;

FIG. 6 is a perspective view showing the support plate viewed from the front;

FIG. 7 is a perspective view showing a front core viewed from the rear;

FIG. 8 is a perspective view showing a rear core viewed from the front;

FIG. 9 is a perspective view showing the rear core viewed from the rear;

FIG. 10 is a vertical cross-sectional view of the headrest (a cross-sectional view taken along Line X-X in FIG. 2);

FIG. 11 is a vertical cross-sectional view of the headrest (a cross-sectional view taken along Line XI-XI in FIG. 2); and

FIG. 12 is a vertical cross-sectional view of the headrest (a cross-sectional view taken along Line XII-XII in FIG. 2).

### DESCRIPTION OF THE PREFERRED EMBODIMENT(S)

Embodiments of a headrest according to the present invention will be described with reference to the appended drawings. The headrest is configured to be attached to a vehicle seat. In the following description, a headrest of the present invention embodied as a headrest for a vehicle seat will be described.

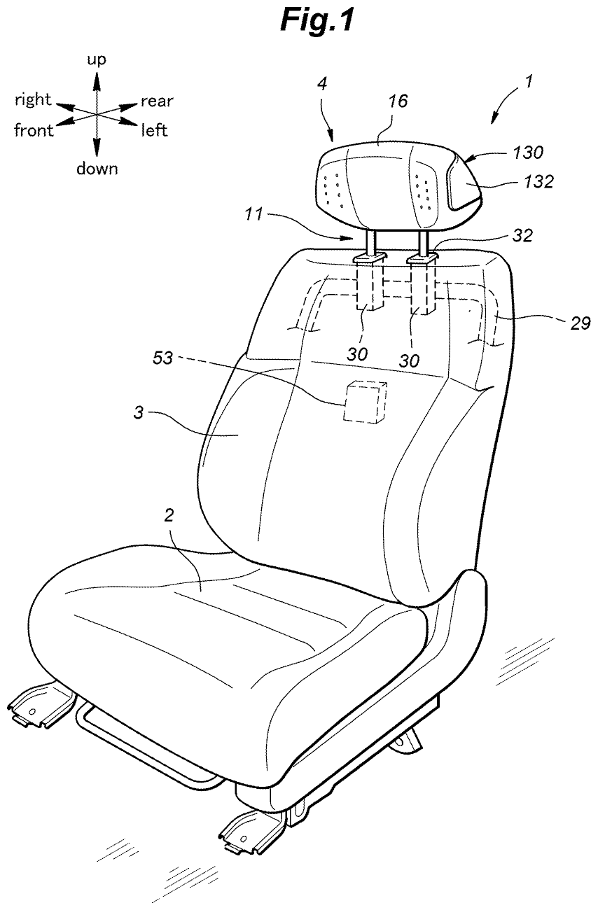

As shown in FIG. 1, a seat 1 includes a seat cushion 2, a seat back 3, and a headrest 4. The seat cushion 2 supports the buttocks of the user from below. The seat back 3 extends upward from the rear of the seat cushion 2. The seat back 3 supports a user's back from behind. The headrest 4 is provided at the upper end of the seat back 3. The headrest 4 supports the user's head from behind.

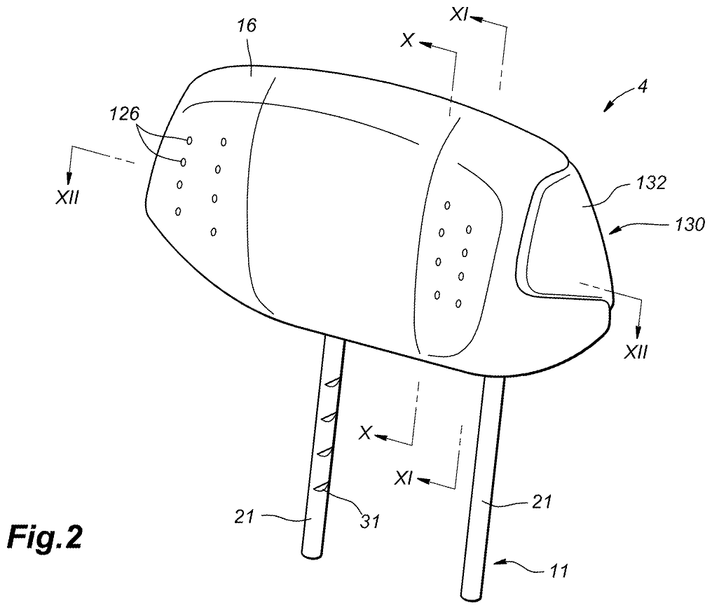

As shown in FIGS. 2 to 4, the headrest 4 includes a headrest pillar 11, a headrest body 12, at least one speaker 13, a pad 14, at least one shape retainer 15, and a skin cover 16.

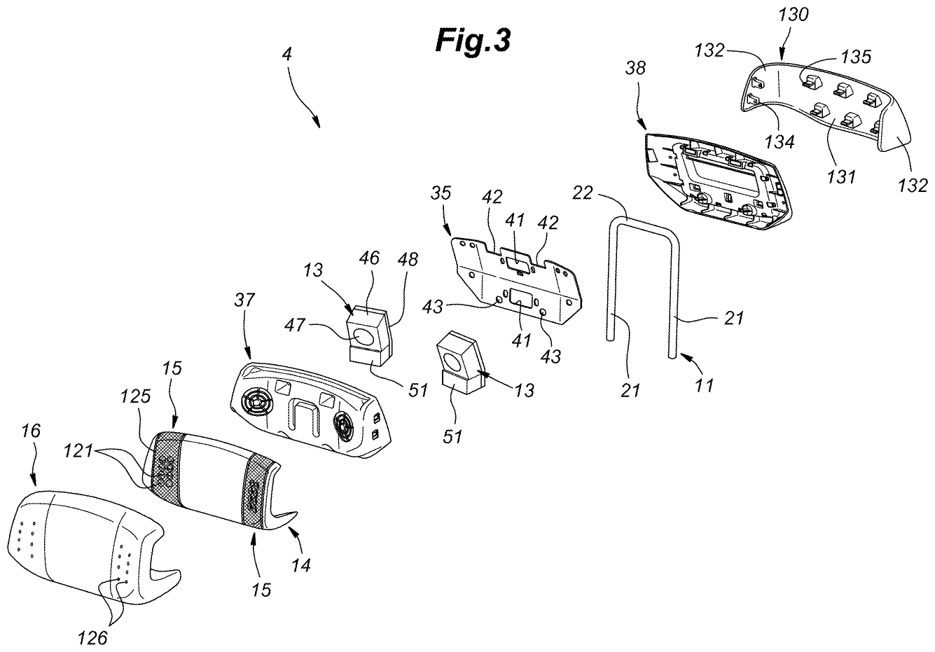

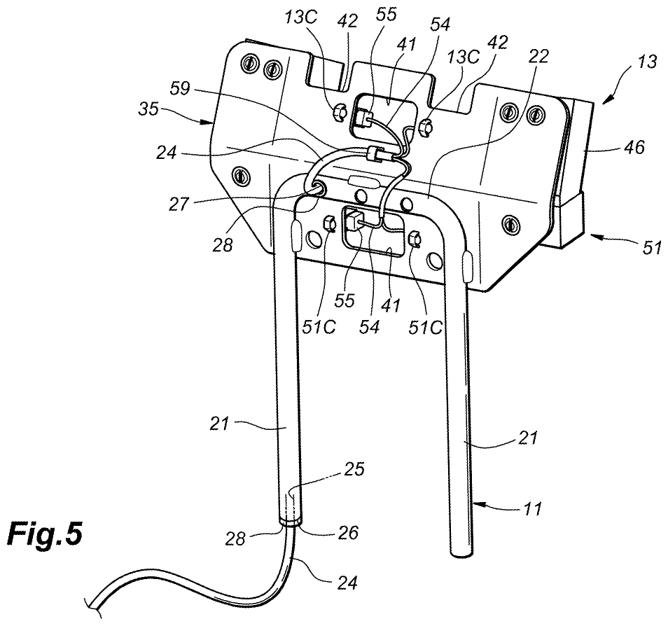

As shown in FIG. 1, the headrest pillar 11 is supported by the seat back 3. As shown in FIGS. 3 and 5, the headrest pillar 11 includes left and right vertical portions 21 extending vertically, and a horizontal portion 22 extending horizontally and connected to the upper ends of the left and right vertical portions 21. The right and left vertical portions 21 and the horizontal portion 22 define a passage hole 25, which a wire harness 24 is inserted to pass through. The passage hole 25 has lower openings 26 at the lower ends of the left and right vertical portions 21. The passage hole 25 also has one or more upper openings 27 in the horizontal portion 22. Each of the lower openings 26 and the upper openings 27 is provided with a grommet 28 attached thereto. The grommet 28 may be formed of a plastic material. The headrest pillar 11 may be formed by bending a metal pipe.

As shown in FIG. 1, the left and right vertical portions 21 are supported by a seat back frame 29, which forms a framework of the seat back 3. The seat back frame 29 has left and right pillar supports 30 that receive the vertical portions 21. The pillar supports 30 are formed in a cylindrical shape with openings at both ends. The pillar supports 30 may be formed of a plastic material. The vertical portions 21 are configured to be inserted into the corresponding pillar supports 30. The lower ends of the vertical portions 21 inserted into the pillar supports 30 protrude from the lower ends of the pillar supports 30. As shown in FIG. 2, a plurality of vertically spaced apart engagement grooves 31 are formed on the outer surface of each vertical portion 21. As shown in FIG. 1, each of the pillar supports 30 is provided with a locking device 32 that selectively engages one of the plurality of engagement grooves 31. Selection of one of the plurality of engagement grooves 31 that the locking devices 32 engages for each of the left and right pillar supports 30 determines the height of the headrest 4 relative to the seat back 3.

As shown in FIGS. 3 to 6, the headrest body 12 is coupled to the headrest pillar 11. The headrest body 12, which is coupled to the headrest pillar 11, includes a support plate 35 having opposing sides facing frontward and rearward, a front core 37 provided on the front side of the support plate 35 such that an internal space 36 is formed between the front core 37 and the support plate 35, and a rear core 38 provided on the rear side of the support plate 35. The support plate 35 may be formed by a metal plate. The front core 37 and the rear core 38 may be formed by a plastic material.

The support plate 35 with the opposing sides facing frontward and rearward extends in a left-right direction. The headrest pillar 11 is coupled to the rear surface of the support plate 35. More specifically, the horizontal portion 22 and the left and right vertical portions 21 may be welded to the rear surface of the support plate 35.

At least one central opening 41 is formed in a center part of the support plate 35, extending through the support plate 35 in a thickness direction. Left and right engagement grooves 42, which are recessed downward, are defined in the upper edge of the support plate 35. At least one first fastening hole 43 is formed in the lower part of the support plate 35, extending through the support plate 35 in the thickness direction.

A pair of speakers on the left and right; that is, left and right speakers 13 are provided inside and supported by the headrest body 12. The left and right speakers 13 are located at the left and right end parts of the front surface of the support plate 35. Each of the speaker 13 has speaker case 46 having a long, vertical, rectangular shape. A speaker unit 47 is provided inside the speaker case 46 and configured to output sound. The speaker unit 47 is exposed at the front of the speaker case 46 and outputs sound toward the front of the speaker case 46. Each speaker 13 may have a sound absorber 48 for absorbing sound output from the speaker and attached to the front surface of the support plate 35. The sound absorber 48 may be an anti-vibration part, such as a rubber sheet or a felt sheet. The sound absorbers 48 reduce vibrations transmitted from the speakers 13 to the support plate 35.

A microphone unit 51 is coupled to the lower end of each speaker 13. In other cases, no microphone unit 51 may be used.

Each speaker 13 and each microphone unit 51 are connected to a control device 53 by a wire harness 24. The control device 53 is an electronic control unit; that is, an arithmetic unit having a microprocessor (MPU), a nonvolatile memory, a volatile memory, and an interface. The control device 53 implements various applications by having the microprocessor execute programs stored in the nonvolatile memory. The control device 53 may be located inside the seat back 3, below the seat cushion 2, or at any other proper location.

As shown in FIG. 5, the wire harness 24 is provided to extend from the inside of the seat back, passing through the lower opening 26, the passage hole 25, and the upper opening 27 to reach the inside of the headrest 4. The wire harness 24 is supported by a harness fastener 59, which is coupled to the rear surface of the support plate 35. The harness fastener 59 is a plastic clip having a ring portion which the wire harness 24 can pass through. The harness fastener 59 is fastened to a fastening hole formed on the support plate 35 by a fastening claw. The upper end of the wire harness 24 is branched into a plurality of branches 54. Each branch 54 passes through the central opening 41 and extends to the front side of the support plate 35. Each of the branches 54 is provided with a connector 55.

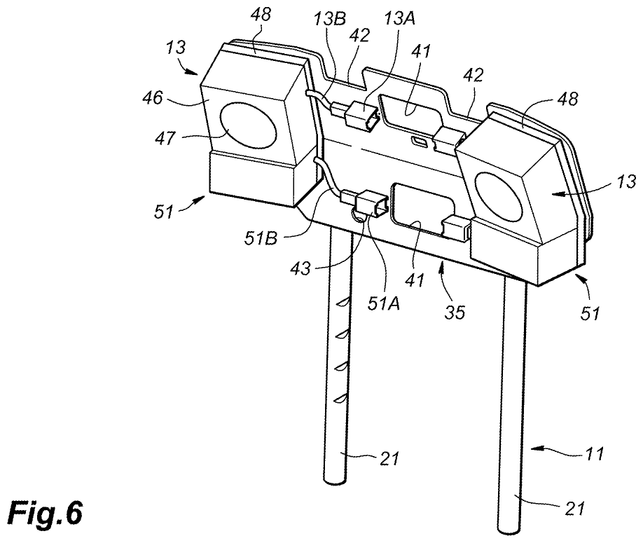

As shown in FIG. 6, each speaker 13 includes a harness 13B and one end of the harness 13B is provided with a connector 13A. Similarly, each microphone unit 51 includes a harness 51B and one end of the harness 15B is provided with a connector 51A. The connectors 13A and 51B have respective fastening claws 13C and 51C. The fastening claws 13C, 51C engage fastening holes formed on the support plate 35. As a result, each connector 13A, 51A is attached to the front surface of the support plate 35. Each connector 13A, 51A may be located near and around the two or more central openings 41. In the present embodiment, the connectors 13A are located on the both sides of the upper central opening, while the connectors 51A are located on the both sides of the lower central opening. Each connector 55 is connected to a corresponding one of the connectors 13A and 51A.

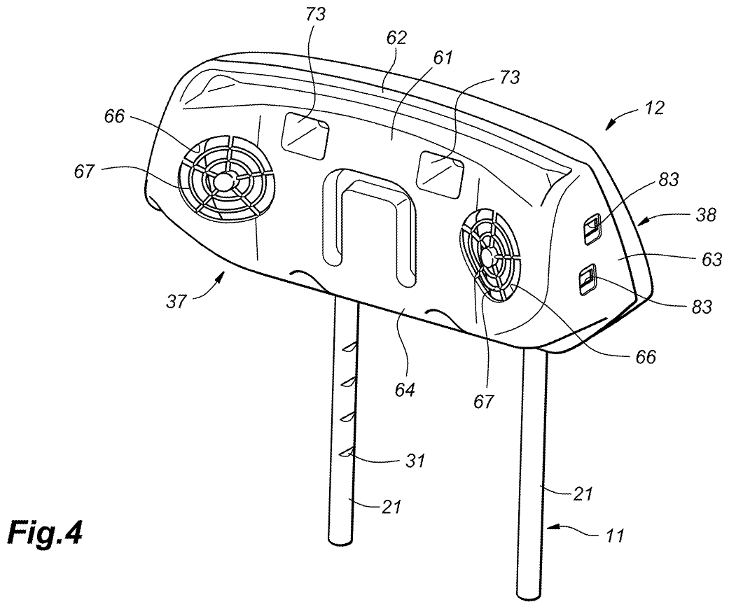

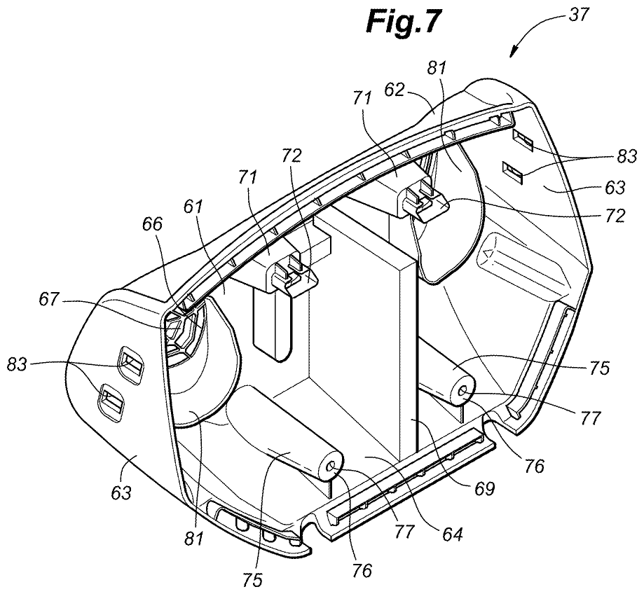

As shown in FIGS. 4 and 7, the front core 37 is formed in a box shape with a rearward opening. The front core 37 has a front wall 61 having opposing sides facing front and rearward; an upper wall 62 extending rearward from the upper edge of the front wall 61; right and left side walls 63 extending rearward from the right and left side edges of the front wall 61; and a lower wall 64 extending rearward from the lower edge of the front wall 61. The left and right parts of the front wall 61 extend obliquely to the front in the directions to the left and right, respectively.

The front core 37 defines at least one core opening 66 that extends therethrough in the front-rear direction, at a location facing the at least one speaker 13. In the present embodiment, the core openings 66 are formed at the left and right parts of the front wall 61. Each of the left and right core openings 66 is provided with a grid 67.

A partition wall 69 protruding rearward and extending vertically is provided at the center of the rear surface of the front wall 61. The partition wall 69 may be connected to the upper wall 62 and lower wall 64. The partition wall 69 may be integrally formed with the front core 37. The partition wall 69 may be a separate part from the front core 37 and may be formed by a different member. The partition wall 69 may be formed by a sound absorber, such as urethane foam, and may be attached to the front core 37.

In an upper part of the rear surface of the front wall 61, a pair of left and right upper bosses 71 are provided to protrude rearward. The left and right upper bosses 71 are located on the left and right sides of the partition wall 69, respectively. The rear end of each of the left and right upper bosses 71 is provided with a coupling piece 72 extending rearward. The coupling piece 72 has a claw extending downward. Each of the left and right upper bosses 71 has a cutout space 73 defined within the upper boss. The cutout spaces 73 open on the front surface of the front wall 61.

In a lower part of the rear surface of the front wall 61, a pair of left and right lower bosses 75 are provided to protrude rearward. The left and right lower bosses 75 are located on the left and right sides of the partition wall 69, respectively. The left and right lower bosses 75 are cylindrical in shape and each have an end part 76 at the rear end. Each end part 76 has a second fastening hole 77 formed within a lower boss extending in the front-rear direction.

As shown in FIGS. 7 and 10 to 12, funnels 81 are provided at the respective edges of the core openings 66 so that the funnels 81 extend toward the corresponding speakers 13. The funnels 81 are cylindrical in shape and extend rearward from the rear surface of the front wall 61. The rear ends of the funnels 81 face the corresponding speaker units 47, each being configured to output sound.

As shown in FIGS. 4 and 7, each of the left and right side walls 63 of the front core 37 defines a plurality of first cover fastening holes 83. The plurality of first cover fastening holes 83 extend through the corresponding side wall 63 in the thickness direction.

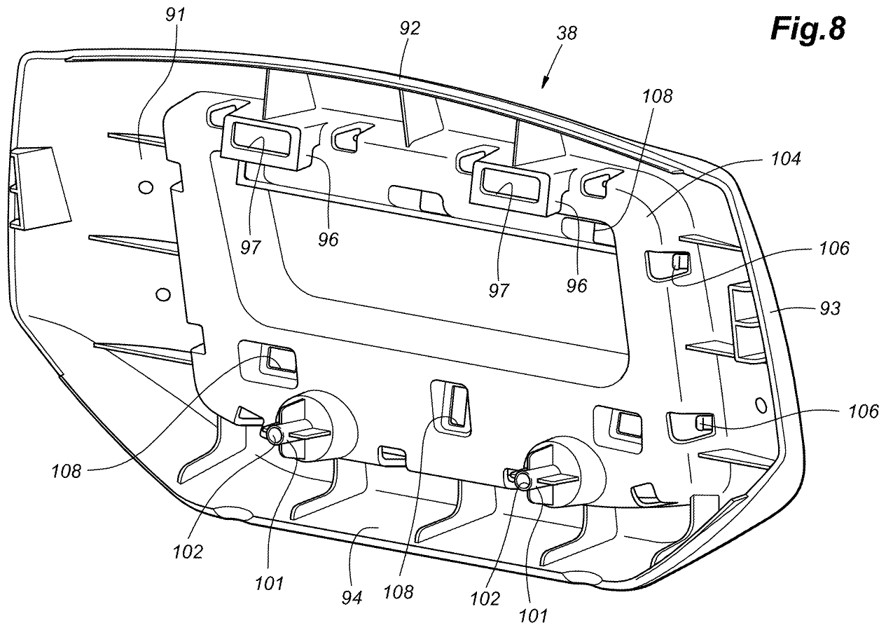

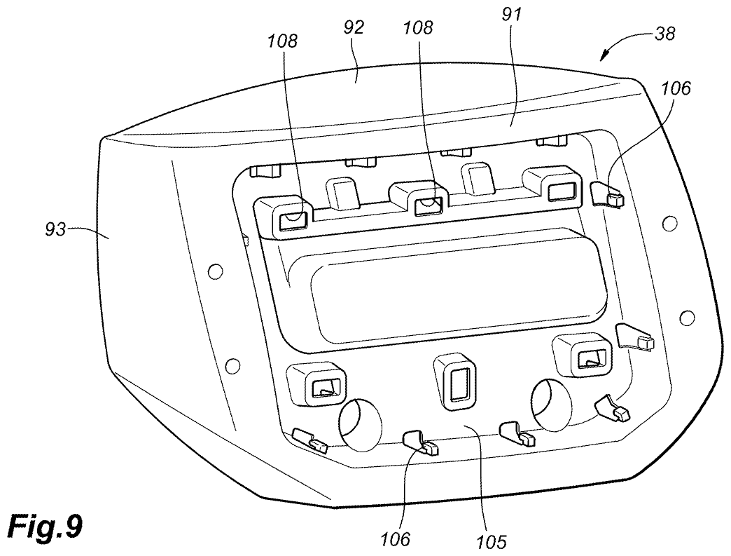

As shown in FIGS. 8 and 9, the rear core 38 is formed in a box shape with a frontward opening. The rear core 38 has a rear wall 91 having opposing sides facing front and rearward; an upper wall 92 extending frontward from the upper edge of the rear wall 91; right and left side walls 93 extending frontward from the right and left side edges of the rear wall 91; and a lower wall 94 extending frontward from the lower edge of the rear wall 91.

In an upper part of the front surface of the rear wall 91, a pair of left and right rear hooks 96 are provided to protrude frontward and extend downward. The front end of each of the left and right rear hooks 96 has a coupling hole 97 that recesses rearward. The coupling holes 97 are configured to receive the coupling pieces 72.

In a lower part of the front surface of the rear wall 91, a pair of left and right rear bosses 101 are provided to protrude frontward. Each of the rear bosses 101 has a female threaded hole 102 formed therein. Each female threaded hole 102 extends rearward from the front end face of a corresponding one of the rear bosses 101.

At least one protrusion 104 protruding frontward is formed on the front surface of the rear wall 91. The at least one protrusion 104 may be in the form of a single member or may be formed by multiple members separated from each other. In the present embodiment, the at least one protrusion 104 is formed in the shape of a ring in a center part of the front surface of the rear wall 91. The at least one protrusion 104 is connected to the left and right rear hooks 96 and to the left and right rear bosses 101. A recess 105 recessed in the front direction of the headrest is formed on the rear surface of the rear wall 91 at a location corresponding to the at least one protrusion 104. A plurality of skin hooks 106 are provided on a sidewall defining the recess 105, which forms the edge of the recess 105. A plurality of second cover fastening holes 108 extending through the rear wall are formed in the bottom of the recess 105.

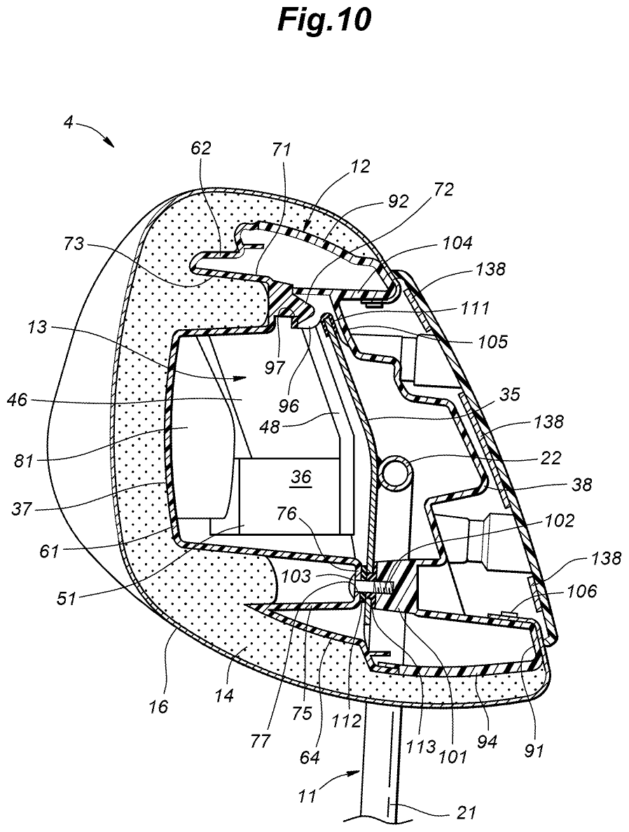

As shown in FIG. 10, the left and right rear hooks 96 hook into the left and right engagement grooves 42 of the support plate 35. As a result, the rear core 38 is supported by the support plate 35. In this situation, the at least one protrusion 104 contacts the rear surface of the support plate 35 and the right and left vertical portions 21 of the headrest pillar 11. The front end of each of the left and right rear bosses 101 is in contact with the edge of a corresponding one of the first fastening holes 43 on the rear surface of the support plate 35. In addition, each female threaded hole 102 faces a corresponding one of the first fastening holes 43. In this way, the rear core 38 is supported by the support plate 35. The front end of each of the left and right rear hooks 96 projects to a location frontward of the support plate 35.

The left and right coupling pieces 72 of the front core 37 are inserted into the coupling holes 97 of the corresponding rear hooks 96 and coupled together. As a result, the upper part of the front core 37 is coupled to that of the rear core 38. In this state, the end part 76 of each lower boss 75 of the front core 37 contacts the edge of a corresponding one of the first fastening holes 43 on the front surface of support plate 35. The left and right second fastening holes 77 face the corresponding first fastening holes 43. The front core, the support plate 35, and rear core 38 are fastened to each other by screws 103 that are screwed from the front side of front core 37 into the female threaded holes 102 such that the screws 103 pass through the second fastening holes 77 and the first fastening holes 43. When the front core 37 and the rear core 38 are coupled to each other in this manner, the support plate 35 is held between the front core 37 and the rear core 38.

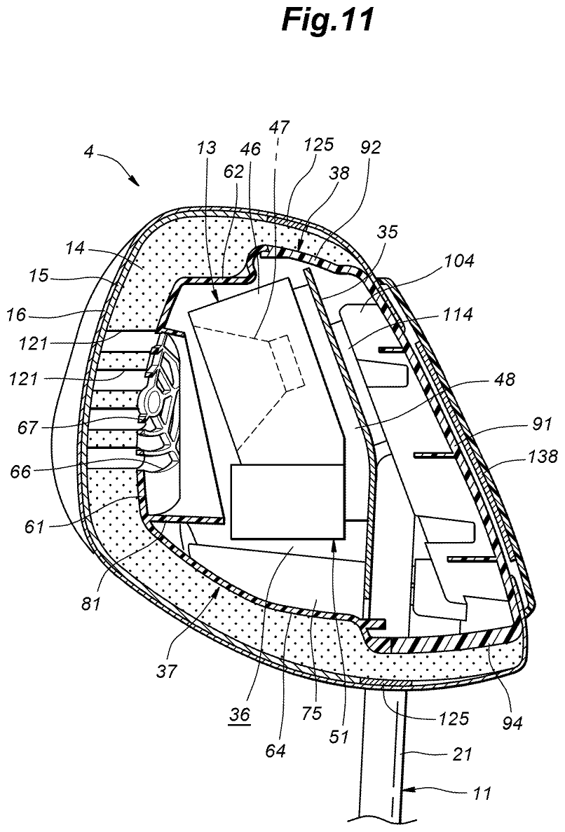

The support plate 35 may be in contact with the front core 37 and the rear core 38 with cushioning parts therebetween, respectively. As shown in FIG. 10, a first cushioning part 111 may be provided between the left rear hook 96 and the left engagement groove 42, and between the right rear hook 96 and the right engagement groove 42. A second cushioning part 112 may be provided between the end part 76 of the left lower boss 75 and the support plate 35, and between the end part 76 of the right lower boss 75 and the support plate 35. A third cushioning part 113 may be provided between the front end of the left rear boss 101 and the support plate 35, and between the front end of the right rear boss 101 and the support plate 35. As shown in FIG. 11, a fourth cushioning part 114 may be provided between the protrusion 104 and the rear surface of the support plate 35, and between the protrusion 104 and the headrest pillar 11. The first to fourth cushioning parts 114 may be formed of a flexible material such as rubber or felt. The first to fourth cushioning parts 114 reduce transmission of vibrations between the support plate 35, the front core 37, and the rear core 38.

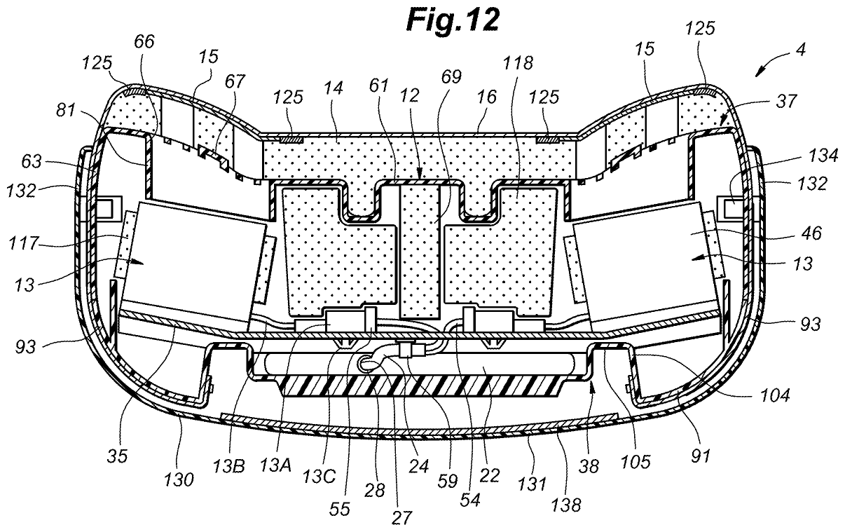

As shown in FIG. 12, when the front core 37 and the rear core 38 are coupled to the support plate 35, the internal space 36 is defined between the support plate 35 and the front core 37. The partition wall 69 of the front core 37 divides the internal space 36 into left and right subspaces. The left and right speakers 13 are located in the internal space 36. When the partition wall 69 is formed of a flexible sound absorber, the rear end of the partition wall 69 may be in contact with the front surface of the support plate 35. When the partition wall 69 is formed as an integral part of the front core 37, the rear end of the partition wall 69 may be away from the front surface of the support plate 35. In this case, the flexible sound absorber may be filled between the rear end of the partition wall 69 and the support plate 35.

A sound absorber 117 is provided around each speaker 13. The sound absorber 117 may be provided in an annular shape around the top surface, bottom surface, and left and right sides of the speaker 13. The sound absorber 117 may be, for example, urethane foam.

A sound absorber 118 is provided between the partition wall 69 and the left speaker 13 and between the partition wall 69 and the right speakers 13. The sound absorbers 118 may be provided along the left and right sides of the partition wall 69. The sound absorber 118 may be filled into the space between the partition wall 69 and the sound absorber 117 which is attached to either of the speakers 13. The sound absorber 118 may be formed of felt, for example.

As shown in FIGS. 10 to 12, the pad 14 is covered by the headrest body 12. In other words, the pad 14 is provided to extend along the outer surface of the front core 37 and the rear core 38. The pad 14 covers at least the front surface of the front wall 61 of the front core 37, the upper wall 62 of the front core 37, the upper wall 92 of the rear core 38, the lower wall 64 of the front core 37, the lower wall 94 of the rear core 38, the left and right side walls 63 of the front core 37, and the left and right side walls 93 of the rear core 38. The pad 14 is formed of a flexible material. The pad 14 may be formed of urethane foam, for example.

The pad 14 has at least one pad opening 121 that faces a speaker 13. In the present embodiment, a plurality of pad openings 121 are located in front of the left and right core openings 66 of the front core 37. Each pad opening 121 is open on the front surface of pad 14. Each pad opening 121 extends through the pad 14 in the thickness direction. In some cases, one pad opening 121 may be formed for one core opening 66. In other cases, a plurality of pad openings 121 may be formed for one core opening 66. In this case, the plurality of pad openings 121 communicate with the corresponding core opening 66.

As shown in FIGS. 3, 11, and 12, in the present embodiment, a pair of shape retainers 15 are provided on the outer surface of pad 14. Each shape retainer 15 is provided along the outer surface of the pad 14 to cover pad openings 121. The edges of a shape retainer 15 are coupled to the outer surface of the pad 14. The shape retainer 15 may be mesh-shaped. The shape retainer 15 is stiffer than the pad 14. The shape retainer 15 may have a higher Young's modulus than the pad 14.

The edge of a shape retainer 15 is provided with a frame 125 that is stiffer than the shape retainer 15. The frame 125 may be formed of a sheet material such as a woven fabric. The frame 125 may have a higher Young's modulus than the shape retainer 15. The shape retainer 15 may be coupled to the outer surface of the pad 14 via the frame 125. In other words, the frame 125 may be coupled to the pad 14. For example, the frame 125 may be bonded to the pad 14 with an adhesive or double-sided tape.

Each shape retainer 15 may vertically extend on the front surface of pad 14 and be coupled to the top and bottom edges of the pad 14. In other embodiments, the upper end of the shape retainer 15 may extend rearward beyond the upper rear edge of the pad 14 and be coupled to the rear core 38. Similarly, the lower end of shape retainer 15 may extend rearward beyond the lower rear end of the pad 14 and be coupled to the rear core 38.

The skin cover 16 is provided so as to cover the pad 14 and the shape retainers 15. The skin cover 16 may be formed in the form of a bag with an opening on the rear side. The edge of the skin cover 16 is secured to a plurality of skin hooks 106 formed on the rear surface of the rear core 38. Parts of the skin cover 16 that face the plurality of pad openings 121 may have a plurality of holes 126 extending through the skin cover 16 in the thickness direction.

As shown in FIGS. 3 and 10 to 12, a rear cover 130 is attached to the rear surface of rear core 38. The rear cover 130 includes a cover middle part 131 extending in the left-right direction, and left and right cover side parts 132 extending frontward from the left and right ends of the cover middle part 131. The cover middle part 131 is formed in the shape of a plate having opposing sides facing frontward and rearward. The left and right cover side parts 132 are formed as plates having sides facing to the left and right. The left and right cover side parts 132 are each provided with first fastening claws 134 that are engageable with the first cover fastening holes 83 extending through a corresponding side wall of the front core 37. The pad 14 and the skin cover 16 have through-holes which the left and right first fastening claws 134 can pass through. The cover middle part 131 is provided with a second fastening claws 135, which are formed at locations corresponding to the plurality of second cover fastening holes 108 of the rear core 38.

The cover middle part 131 of the rear cover 130 covers the recess 105 of the rear core 38 and hides the edges of the skin cover 16. The left and right cover side parts 132 comprise the left and right edges of the headrest 4. The front surface of the rear cover 130 is provided with one or more vibration dampers 138. For example, a plurality of vibration damper 138 may be affixed to the front surface of the cover middle part 131. Each vibration damper 138 may be, for example, a rubber sheet. The vibration dampers 138 may be sandwiched between the rear cover 130 and the rear core 38. The vibration dampers 138 prevent vibration of the rear core 38 and reduce sound transmitted from the headrest 4 to the rear.

Next, a method of manufacturing the headrest 4 of the embodiment of the present invention will be described. First, the headrest pillar 11 is joined to the support plate 35 by welding or any other proper method. Next, the speakers 13 and the microphone units 51 are fastened to the support plate 35 via the sound absorbers 48. Then, the respective connectors 13A of the speakers 13 are fastened to the support plate 35 by the fastening claws 13C. Similarly, the connectors 51A of the microphone units 51 are fastened to the support plate 35 by the fastening claws 51C.

Then, the wire harness 24 is inserted into the passage hole 25 and a pillar support 30 of the headrest pillar 11. First, the wire harness 24 having at least one end with no connector is prepared. For example, when two or more connectors 55 are attached to the wire harness 24, a connector is removed from the end of the wire harness 24 on the side of the control device 53, and the control-device-side end of the wire harness 24 may be inserted through an upper opening 27 into the passage hole 25. Then, after the control-device-side end of the wire harness 24 has been pulled out of a lower opening 26 and passed through the pillar support 30, a connector may be attached to the control-device-side end of the wire harness 24. Each connector 55 is connected to the corresponding one of the connectors 13A and 51A.

Next, the rear core 38 is engageably attached to the support plate 35. Then, the front core 37 is coupled to the rear core 38. As a result, the support plate 35 is sandwiched and held by the front core 37 and the rear core 38. In this way, the headrest body 12 is formed by the support plate 35, the front core 37, and the rear core 38.

Then, the pad 14 is placed over and covers the front core 37 and the rear core 38. Next, the shape retainers 15 with frames 125 is bonded to the surface of pad 14. Next, the skin cover 16 is placed over the pad 14, the shape retainers 15, and the frames 125. The edges of the skin cover 16 are secured to the plurality of skin hooks 106 of the rear core 38.

Next, the rear cover 130 is coupled to the rear core 38 that is coupled to the front core 37, and hides the edges of the skin cover 16. The above-described assembling process produces the headrest 4.

In the headrest 4 of the above-described embodiment, the shape retainers 15 are provided on the outer surface of the pad 14 at the locations of openings of the pad 14, thereby preventing partial deformation of the headrest 4. The shape retainers 15 provide further stiffness to the pad 14, which prevents deformation of the openings of the pad 14. In addition, the frame 125, which is provided at the edge of a shape retainer 15, increases the stiffness of the shape retainer 15, thereby further preventing the deformation of the pad where the pad openings 121 are formed. The shape retainers are arranged to extend over a relatively wide area, resulting in distribution of the load applied to the pad 14, which further prevents partial deformation of the pad 14.

The sound absorbers 117 reduce vibrations transmitted from the speakers 13 to the support plate 35, the front core 37, and the rear core 38. The sound absorbers 118 and the partition wall 69 reduce interference of sound outputs from the left and right speakers 13. The funnels 81 regulate the respective directions of sound outputs from the speakers 13 to thereby cause the sound outputs to be transmitted frontward of the headrest 4. This configuration reduces interference between sound outputs from the left and right speakers 13.

Specific embodiments of the present invention are described herein. However, those embodiments are non-limiting and various modifications may be made to the embodiments without departing from the scope of the present invention. For example, the shape retainers 15 may be provided across the entire surface of the pad 14. In some cases, the shape retainers 15 may be bonded to the rear surface of the skin cover 16.

### GLOSSARY

1 seat
4 headrest
11 headrest pillar
12 headrest body
13 speaker
14 pad
15 shape retainer
16 skin cover
24 wire harness
35 support plate
36 internal space
37 front core
38 rear core
48 sound absorber
51 microphone unit
66 core opening
69 partition wall
81 funnel
111 first cushioning part
112 second cushioning part
113 third cushioning part
114 fourth cushioning part
117 first sound absorber
118 second sound absorber
121 pad opening
125 frame
130 rear cover
138 vibration damper

1. A headrest for a vehicle seat, the headrest comprising:
a headrest pillar supported by a seat back;
a headrest body coupled to the headrest pillar;
at least one speaker supported by the headrest body;
a pad for covering the headrest body, the pad having at least one pad opening which faces the at least one speaker;
a shape retainer which is mesh-shaped, and provided on the outer surface of the pad so as to cover the at least one pad opening, edges of the shape retainer being coupled to the outer surface of the pad; and
a skin cover for covering the pad and the shape retainer.

2. The headrest as claimed in claim 1, wherein a frame is provided at an edge of the shape retainer, the frame being stiffer than the shape retainer, and
wherein the frame is coupled to the pad.

3. The headrest as claimed in claim 2, wherein the at least one pad opening opens on the front surface of the pad, and
wherein the shape retainer extends vertically across the front surface of the pad, and is coupled to the top and bottom edges of the pad.

4. The headrest as claimed in claim 1, wherein the headrest body comprises:
a support plate which is coupled to the headrest pillar and faces frontward and backward; and
a front core which is provided on the front side of the support plate such that an internal space is formed between the front core and the support plate; and
a rear core which is provided on the rear side of the support plate,
wherein the at least one speaker is supported by the front surface of the support plate and is provided in the internal space,
wherein the front core has at least one core opening which extends therethrough in a front-to-rear direction and faces the at least one speaker, and
wherein the at least one speaker is surrounded by a first sound absorber.

5. The headrest as claimed in claim 4, wherein the at least one speaker comprises a left speaker and a right speaker which are provided at left and right parts of the front surface of the support plate, respectively, and
wherein the headrest further comprises a partition wall which is provided at a center part of the internal space along a left-to-right direction so as to divide the internal space into left and right subspaces.

6. The headrest as claimed in claim 5, wherein the at least one core opening comprises left and right core openings, and
wherein the headrest further comprises funnels which are provided at the edges of the left and right core openings and extend toward the left and right speakers, respectively.

7. The headrest as claimed in claim 5, further comprising second sound absorbers provided between the partition wall and the left speaker and between the partition wall and the right speakers, respectively.

8. The headrest as claimed in claim 6, wherein the partition wall is formed of a flexible sound absorber.

9. The headrest as claimed in claim 4, wherein the front core and the rear core are coupled to each other such that the support plate is interposed between the front core and the rear core, and
wherein the support plate is in secure contact with the front core and the rear core, with respective cushioning parts provided therebetween.

10. The headrest as claimed in claim 4, further comprising:
a rear cover coupled to the rear surface of the rear core, and
a vibration damper provided on the front surface of the rear cover.
